(19) United States
(12) Patent Application Publication
(10) Pub. No.: US 2005/0074269 A1
(43) Pub. Date: Apr. 7, 2005

(54) Pen holder

(76) Inventor: Philippe Asselin, Cleveland, TN (US)

Correspondence Address: Micheline Kelly Johnson;Baker, Donelson, Bearman, Caldwell & Berkowitz, PC, 1800 Republic Centre, 633 Chestnut Street, Chattanooga, TN, 37450-1800, US

(21) Appl. No.: 10/677,211

(22) Filed: Oct. 2, 2003

(51) Int. Cl. B43K 23/02

(52) U.S. Cl. 401/131

(57) ABSTRACT

A pen holder in which at least one recess is provided so that a writing instrument may be clasped therein, secured reliably in the holder, and removed easily from the pen holder. The holder may be a separate device or be formed integrally onto the body of a writing instrument. The holder may be made of eraser material so that it may function additionally as an eraser. The holder may have an illuminated clock so that a user may readily discern the time while using the pen holder, even in poorly lit areas, and it may have advertising on its body.

### BACKGROUND OF THE INVENTION

This invention relates generally to writing instruments and more particularly concerns a device for removably securing two or more writing instruments together.

Pens, pencils, markers, highlighters, other writing instruments, and similarly shaped objects (all referred to here generically as “pens” or “writing instruments”), commonly have clips on them to enable the user to clip a pen onto a shirt pocket. Pencils commonly are carried in pencil boxes, and pens in carrying cases. Highlighter markers, however, frequently are so large that they would be obtrusive if carried in a shirt pocket and do not, therefore, generally bear clips. Some highlighters are available in standard pen size, however, and thus may be carried similarly to regular pens if provided with a clip.

Some particular concerns arise when pens, pencils, and highlighters are used together for performing certain tasks. For instance, a pen or pencil may be used for recording items of information, and a highlighter marker for drawing attention to particular items. Similarly, a pen and a thick black marker may be used together—the pen for writing information and the black marker for obliterating certain information. Two instances where either or both of these practices are common are at the maitre d′ station in a restaurant, and when studying academic or other material. Numerous office and workplace situations also call for frequent contemporaneous use of pens for writing and markers for highlighting or obliterating information, such as when performing inventory checks or markdowns.

Numerous patents have been issued for various types of devices to secure pens to pocket-protector inserts, memo pad holders, or clipboards. Legan, U.S. Pat. No. 1,100,583 discloses one such pen and pencil holder for use with a shirt pocket. Similarly, Linton, U.S. Pat. No. 4,650,069, teaches a pocket protector clip with notches for retaining pens, and Harrington, U.S. Pat. No. Des. 256,963, shows another pocket protector with integral clips for holding pens. Chang, U.S. Pat. No. 4,948,172, discloses a clipboard with an integrally formed elongated clip mounting member that provides for storage of a pen or the like. Liu, et al., U.S. Pat. No. 5,058,242, also discloses a clipboard with a pen holder. In Liu, the pen holder is adapted to be attached to the spring of the clipboard. Korowitz, U.S. Pat. No. D477,029 S, teaches a memo holder with an integral pen holder formed on the bottom portion of the clip, and Isaacs, U.S. Pat. No. D469,812 S, illustrates a clip with an integral pen holder formed on the top portion of the clip. Huang, U.S. Pat. No. Des. 419,192, shows a magnet memo clip with an integral pen holder formed in the top portion of the clip. While all these devices provide for storage of writing instruments, either on the person of the user or at the point of use, none offer storage of one pen during use of another pen at the point of use.

Similarly, in Billish, U.S. Pat. No. 5,718,023, a device is provided for securing two or more writing instruments to a small board that can be secured at one's belt or other surface. While Billish provides for storage of more than one writing instrument, it again fails to offer storage at the point of use. Thus, there is a need for a device that permits writing instruments frequently used in conjunction with each other to be removably attached to each other, thereby permitting each device to be kept with its mate and readily found. This would eliminate a problem faced by maitre d's as they attempt, in relatively dark lighting, to handle wait lists, reservations, and the ongoing seating of patrons. At present, a typical maitre d's station may hold various pens, pencils, and markers for use in maintaining a seating chart and patron information. After using one writing instrument for recording information, it will have to be put down and another picked up for use as a highlighter or marker. In darkened restaurants, it can be difficult to readily locate the desired writing instrument in the low-lighting environment. Moreover, dim lighting can make it difficult to read one's watch when noting the time of reservations or expected wait for seating.

It would not be sufficient to adapt the Billish holder or, indeed, any of the other noted holders, to accept large highlighter markers as well as standard size pens and pencils because it is also necessary to solve the problem of keeping multiple, contemporaneously used writing instruments together at the point of use. Indeed, it would be helpful to have a holder that permits the user to employ one of the writing instruments while retaining the other clipped to its side.

A common writing instrument that solves a similar problem is the Bic Four Color pen. It provides for storage of multiple colors of ink within the same pen barrel. In this device, the user clicks a particular ink cartridge down for use, depending upon the color of ink desired. However, there is no similar device permitting the use of marker ink together with pen ink. It would not be satisfactory to modify the Bic device to provide for marker fluid to descend from the writing instrument when desired, because markers utilize fibrous ends to dispense marker fluid, whereas pens use a variety of roller surfaces to dispense ink. The dimensions of the two dispensing systems, even for a slim marker, are different enough that one could expect difficulty when attempting to combine the two into one device. Rather, it would be better to provide some sort of holding device that would allow for the removal of spent markers and pens, and replacement with fresh writing instruments.

### SUMMARY OF THE INVENTION

Accordingly, it is the primary aim of this invention to provide secure storage of multiple writing instruments at the point of use. It is a further aim of this invention to facilitate the contemporaneous use of more than one writing instrument in a pair or set while storing on that writing instrument the alternate writing instrument(s).

It is a further object of this invention to provide a pen holder with an integral clock, preferably digital and with lighting for use in dark environments. In one of its aspects, the invention is an independent device with recesses for holding two or more writing instruments. In another of its aspects, it is a device integral to a writing instrument, such that one or more additional writing instruments may be removably attached thereto.

Another object of the invention is to facilitate the promotion of an entity or idea via available space on the pen clip itself.

The foregoing objectives are achieved by a pen holder comprising a body, the body having a first recess and a second recess, so that a writing instrument can be inserted into the first recess and another writing instrument can be inserted into the second recess, the body being flexible so that a writing instrument inserted into a recess is removably retained therein.

Alternatively, the pen holder may be provided integrally on a first writing instrument and provide at least one recess for the insertion of at least one additional writing instrument.

In addition, the pen holder of the present invention may indicate time. Either aspect of the invention may provide an integral clock thereon so that the user may readily know what time it is during use. Moreover, either aspect of the invention may promote a business, sponsor, idea, or cause by advertising on the pen clip itself.

### BRIEF DESCRIPTION OF THE DRAWINGS

FIG. 1 is a perspective view of the pen holder of the present invention;

FIG. 2 is an elevation view showing the integral clock in an embodiment of the present invention;

FIG. 3 is an elevation view showing the pen holder of the present invention clasping a pen and a marker;

FIG. 4 is a top view of an embodiment of the present invention;

FIG. 5 is a top view of an alternate embodiment of the present invention; and

FIG. 6 is an elevation view of another alternate embodiment of the present invention.

### DETAILED DESCRIPTION OF THE INVENTION

While the invention will be described in connection with preferred embodiments, it will be understood that I do not intend to limit the invention to those embodiments. On the contrary, I intend to cover all alternatives, modifications, and equivalents as may be included within the spirit and scope of the invention as defined by the appended claims.

Turning first to FIG. 1, there is shown a pen holder 10 embodying the present invention. The pen holder 10 is used to hold a pen or pencil and a marker. The pen holder 10 has a body 11 with two recesses for accepting writing instruments. Body 11 is made of any material flexible enough to removably retain a writing instrument. Hard or soft rubber and various rubber-like materials are suitable. If made of a soft rubber, the pen holder 10 may also function as an eraser.

First recess 12 is sized to accept a pen or pencil or other standard or similarly shaped object. Second recess 13 is shaped to accept a much larger highlighter or other marker. Thus, first inside surface 14 is smaller in size to fit the standard writing instrument or pen, whereas second inside surface 15 is much larger in size to accept the much larger marker.

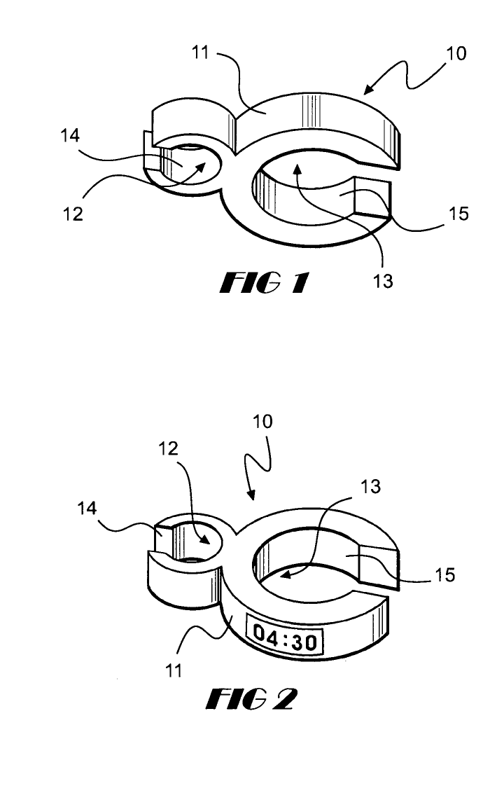

FIG. 2 shows a preferred embodiment of the present invention which incorporates an integral, digital, lighted clock.

FIG. 3 shows the pen holder 10 of the present invention in use retaining pen 16 and marker 17 simultaneously. Either pen 16 or marker 17 can be used while retaining the other writing instrument in pen holder 10 alongside the writing instrument being used. The retained writing instrument will merely rest above the writing instrument being held by the user, as pen holder 10 will position it comfortably parallel to the instrument being held and used. Alternately, either writing instrument may be removed from pen holder 10 for use and replaced therein after use.

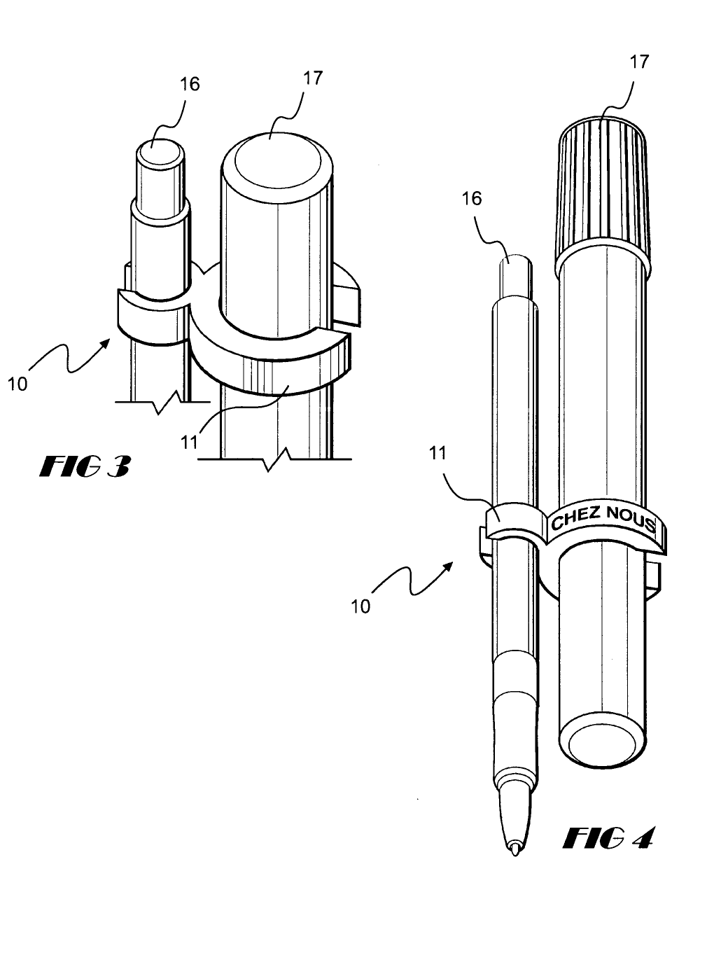

FIG. 4 shows the pen holder 10 in use retaining pen 16 and marker 17 simultaneously, but in the opposite direction from each other. Either pen 16 or marker 17 can be used while the other writing instrument extends essentially behind the writing instrument being used. FIG. 4 also shows some advertising on the pen holder 10 for a restaurant utilizing the device at its maitre d's station.

FIG. 5 shows an alternate embodiment of pen holder 10. This embodiment reflects a generally rectangular design of body 11 as opposed to the generally double-c shaped design shown in FIGS. 1-3.

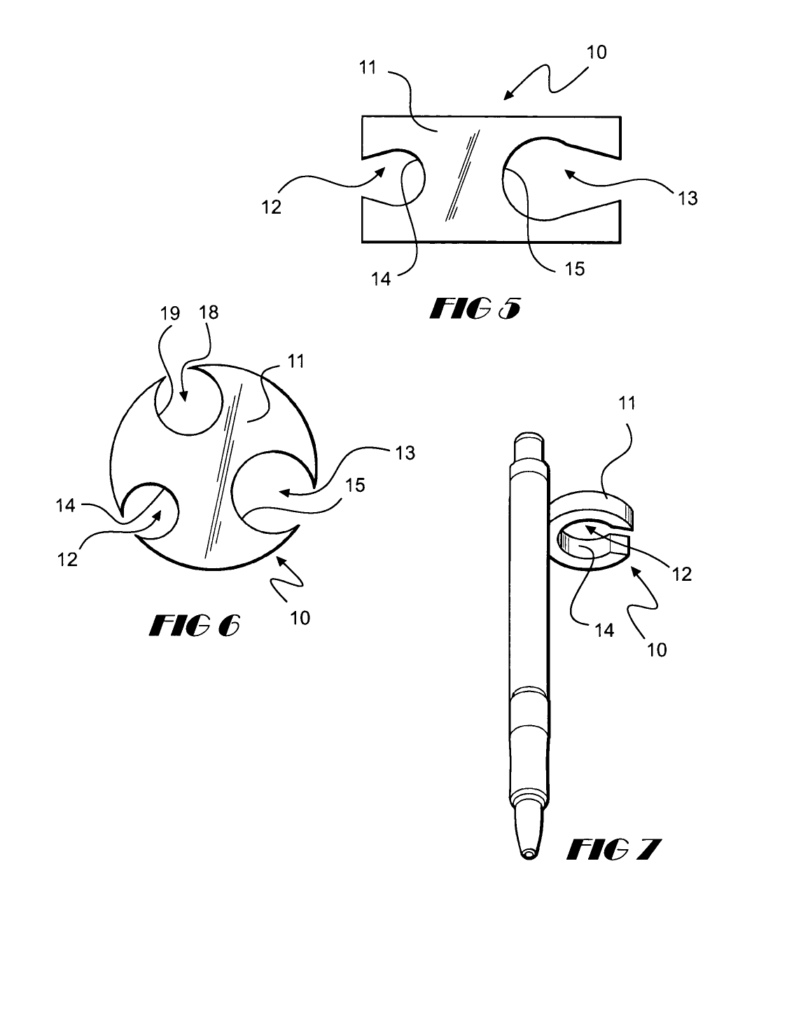

FIG. 6 shows an additional alternate embodiment of pen holder 10. Here, three recesses are provided for retaining three different writing instruments. First recess 12, second recess 13, and third recess 18 may be of the same or different dimensions, so as to accept either writing instruments of approximately standard pen size, or the larger marker size, any combination of the two, or any variation in size to fit a particular writing instrument or other device.

FIG. 7 shows yet another alternate embodiment of the present invention. Here, pen holder 10 is provided as an integral part of pen 20. Body 11 may be formed of any material flexible enough to accept a writing instrument into recess 12. Inside surface 14 may have dimensions sized to accept standard shaped pens or pencils, or the larger markers, as desired.

1. A pen holder comprising:
a flexible body, the body having a first recess at a first end for removably receiving a writing instrument of a first radial dimension, and a second recess at a second opposing end for removably receiving a writing instrument of a second larger radial dimension.

2. A pen holder comprising:
a flexible body, the body having a plurality of recesses, so that a first writing instrument of a first radial dimension can be inserted into at least a first recess and a second writing instrument of a second larger radial dimension can be inserted into at least a second recess, the body being flexible so that the writing instruments may be removably inserted into the respective recesses.

3. The pen holder of claim 1, wherein the first recess is sized to receive a pen, and the second recess is sized to receive a marker.

4. (Cancelled)

5. The pen holder of claim 2, wherein the first of the plurality of recesses is sized to receive a pen, and the second of the plurality of recesses is sized to receive a marker.

6. (Cancelled)

7. A writing instrument comprising a body, the body having an integral pen holder member extending therefrom, the pen holder member having a recess and being flexible so that a writing instrument inserted into the recess is removably retained therein.

8. The pen holder of claim 1, wherein the body has an integral clock.

9. The pen holder of claim 2, wherein the body has an integral clock.

10. The writing instrument of claim 7, wherein the body has an integral clock.

11. The pen holder of claim 1, wherein the body is made of eraser material.

12. The pen holder of claim 2, wherein the body is made of eraser material.

13. The writing instrument of claim 7, wherein the body is made of eraser material.

14. The pen holder of claim 1, wherein the body contains advertising material.

15. The pen holder of claim 2, wherein the body contains advertising material.

16. The writing instrument of claim 7, wherein the body contains advertising material.
